(19) United States
(12) Patent Application Publication
(10) Pub. No.: US 2011/0008678 A1
(43) Pub. Date: Jan. 13, 2011

(54) ELECTRODE MATERIALS FOR SECONDARY (RECHARGEABLE) ELECTROCHEMICAL CELLS AND THEIR METHOD OF PREPARATION

(75) Inventors: Yi-Qun Li, Danville, CA (US); Xufang Chen, Newark, CA (US)

Correspondence Address: FLIESLER MEYER LLP, 650 CALIFORNIA STREET, 14TH FLOOR, SAN FRANCISCO, CA, 94108, US

(73) Assignee: INTEMATIX CORPORATION, Fremont, CA (US)

(21) Appl. No.: 12/729,005

(22) Filed: Mar. 22, 2010

Related U.S. Application Data
(60) Provisional application No. 61/224,783, filed on Jul. 10, 2009.

(51) Int. Cl. H01M 4/583; H01M 4/88

(52) U.S. Cl. 429/231.8; 252/182.1

(57) ABSTRACT

An electrode material for a rechargeable electrochemical cell comprises a metal phosphate of general composition M1M2PO₄ having an olivine structure in which alkali metal cations (M^{I}=Li⁺, Na⁺, K⁺) occupy M1 sites and transition metal cations (M^{V}=Fe, Mn, Co) having both divalent and trivalent oxidation states occupy M2 sites. The material further comprises trivalent and/or tetravalent metal cations (M^{III}=Al³⁺, Ga³⁺, In³⁺, Tl³⁺, Y³⁺, La³⁺, V³⁺, Cr³⁺, Mn³⁺, Fe³⁺, Co³⁺, Ti⁴⁺, M^{IV}=Zr⁴⁺, Mo⁴, W⁴⁺) doped into an M2 site and additional alkali metal cations doped into an M2 site to thereby attain an overall charge balance of the material.

### CLAIM OF PRIORITY

This application claims priority to U.S. Provisional Patent Application No. 61/224,783 entitled “LITHIUM IRON PHOSPHATE BASED MATERIALS” by Inventors Yi-Qun Li and Xufang Chen, filed Jul. 10, 2009, the contents of which are incorporated herein by reference.

### BACKGROUND OF THE INVENTION

1. Field of the Invention

This invention relates to electrode materials for secondary (rechargeable) electrochemical cells and their method of preparation. More particularly, although not exclusively, the invention concerns electrode materials for rechargeable alkali metal ion electrochemical cells, in particular rechargeable lithium-ion cells. The invention further concerns alkali metal electrochemical cells utilizing the electrode material of the invention.

2. Description of the Related Art

In the rechargeable electrochemical cell (battery) industry, a variety of different cathode materials have been investigated. Lithium cobalt oxide, LiCoO₂, is the most common cathode material used today in commercial Li-ion batteries, by virtue of its high working voltage and long cycle life. Although LiCoO₂ is considered the cathode material of choice, the high cost, toxicity and relatively low thermal stability are features where the material has serious limitations as a rechargeable battery cathode. In a LiCoO₂ cell, approximately 50% of the Li remains in a fully charged cathode. However, as the 50% of the lithium that does migrate to the cathode in a LiCoO₂ cell during discharging, is added, the CoO₂ undergoes non-linear expansion that can affect the structural integrity of the cell. These limitations have stimulated a number of researchers to investigate methods of treating the LiCoO₂ to improve its thermal stability. However, the safety issue due to low thermal stability is still the critical limitation for LiCoO₂ cathode materials, especially when the battery is used in high charging-discharging rate conditions. Therefore, LiCoO₂ is not considered suitable as a cathode material in rechargeable batteries for electric vehicles and this has stimulated searches for alternative cathode material for use with electric vehicles and hybrid electric vehicles.

Lithium iron phosphate, LiFePO₄, has been investigated as a very attractive alternative cathode material in Li-ion rechargeable batteries due to its high thermal stability. Lithium is depleted from the cathode of a LiFePO₄ electrode active material on charging. But in the case of a LiFePO₄ electrode material, the fully lithiated and un-lithiated states of the LiFePO₄ electrode material are structurally similar. As a result, LiFePO₄ cells are more structurally stable than LiCoO₂ cells. Moreover LiFePO₄ is highly resistant to oxygen loss, which typically results in an exothermic reaction in other lithium cells. Another advantage for LiFePO₄ as an electrode active material is the high current or peak-power rating. These advantages make LiFePO₄ electrode active materials suitable for high rate charge-discharge applications in electric vehicles and power tools. Batteries using LiFePO₄ as the cathode material have achieved market penetration in electric bicycles, scooters, wheel chairs and power tools.

The LiFePO₄ battery uses a Li-ion-derived chemistry and shares many of its advantages and disadvantages with other Li-ion battery chemistries. The key advantages for LiFePO₄ are the safety (resistance to thermal runaway) and the high current or peak-power rating.

An alternative electrode material for use in rechargeable batteries has the rhombohedral NASICON (Sodium Super-Ionic Conductor) structure with general formula, YₓM₂(ZO₄)₃ where Y=lithium (Li) or sodium (Na) and Z=silicon (Si), phosphorus (P), arsenic (As), or sulfur (S). The rhombohedral NASICON structure forms a framework of MO₆ octahedra sharing all of their corners with ZO₄ tetrahedra, the ZO₄ tetrahedra sharing all of their corners with octahedra. Pairs of MO₆ octahedra have faces bridged by three XO₄ tetrahedra to form “lantern” units aligned parallel to the hexagonal c-axis (the rhomobhedral [111] direction), each of these XO₄ tetrahedra bridging to two different “lantern” units. The Li⁺ or Na⁺ ions occupy the interstitial space within the M₂(ZO₄)₃ framework.

U.S. Pat. Nos. 6,528,033, 6,716,372, 6,702,961 and 7,438,999, all to Barker et al., concern Li-based mixed metal electrode materials of general formula LiMI_{1-y}MII_{y}PO₄ where MI is a metal such as iron (Fe), cobalt (Co), nickel (Ni), manganese (Mn), copper (Cu), vandium (V), tin (Sn), titanium (Ti) or chromium (Cr) and MII is a metal such as magnesium (Mg), calcium (Ca), zinc (Zn), strontium (Sr), lead (Pb), cadmium (Cd), Sn, barium (Ba) or beryllium (Be).

U.S. Pat. No. 7,629,080 to Allen et al. discloses lithiated metal phosphate materials that are doped with lithium ions which are present at M2 octahedral sites of the material. The material has the general formula Li₁₊ₓM_{1-x-d}D_{d}PO₄ in which M is a divalent ion Fe, Mn, Co or Ni, D is a divalent metal Mg, Ca, Zn or Ti and is present in amounts d where 0≧d≧0.1. The portion of lithium present at the M2 sites is given by 0.07≧x≧0.

U.S. Pat. No. 5,910,382 to Goodenough et al. teaches a cathode material for a rechargeable alkali-ion, in particular Li-ion, battery comprising an ordered olivine compound of formula LiMPO₄ where M is at least one first row transition metal cation selected from Mn, Fe, Co, Ti or Ni. U.S. Pat. No. 6,514,640 to Armand et al., which is a continuation-in-part of U.S. Pat. No. 5,910,382, further teaches a cathode material for a rechargeable Li-ion battery comprising ordered olivine phosphate, sulphate, silicate or vanadate compounds of general formula Li_{x+y}M_{1-(y+d+t+q+r)}D_{d}TₜQ_{q}Rᵣ[PO₄]₁₋₍ₚ₊ₛ₊ᵥ₎[SO₄]ₚ[SiO₄]ₛ[VO₄]ᵥ where M is may be Fe²⁺ or Mn²⁺; D is a metal having a +2 oxidation, preferably Mg²⁺, Co²⁺, Zn²⁺, Cu²⁺ or Ti²⁺; T is a metal having a +3 oxidation state, preferably aluminum (Al³⁺), Ti³⁺, Cr³⁺, Fe³⁺, Mn³⁺, Ga³⁺, Zn³⁺ or V³⁺; Q is a metal having a +4 oxidation state, preferably Ti⁴⁺, germanium (Ge⁴⁺), Sn⁴⁺, or V⁴⁺; R is a metal having a +5 oxidation, preferably V⁵⁺, niobium (Nb⁵⁺) or tantalum (Ta⁵⁺); and in which 0≦x≦1, y+d+t+q+r<1, p+s+v<1 and 3+s−p=x−y+t+2q+3r, x, y, d, t, q, r, p, s, and v may vary between zero and one and where at least one of the y, d, t, q, r, p, s v is not zero.

U.S. Pat. No. 7,482,097 to Saidi et al. teaches an electrode material of formula AₐM_{b}XY₄ where A is an alkali metal, and 0<a≦2; M comprises one or more metals including at least one that is capable of undergoing oxidation to a higher valence state and at least one +3 oxidation state non-transition metal, and 0<b<2; XY₄ is an anion and selected from the group consisting of X′O₄₋ₓY′ₓ, X′O_{4-y}Y′_{2y}, X″S₄, and mixtures thereof, where X′ is P, As, antimony (Sb), Si, Ge, V, S and mixtures thereof, X″ is P, As, Sb, Si, Ge, V, S and mixtures thereof, Y′ is S, N, and mixtures thereof; 0≦x≦3; and 0<y≦2; wherein M, XY₄, a, b, x and y are selected so as to maintain electro-neutrality of the compound.

U.S. Pat. No. 7,338,734 to Chiang et al. discloses compositions with improved conductivity having an olivine structure and of a composition Aₓ(M′₁₋ₐM″ₐ)_{y}(XD₄)_{z}, where A is an alkali metal or hydrogen; M′ is a first-row transition metal; X is at least one of P, S, As, B, Al, Si, V, molybdenum (Mo) and tungsten (W); M″ is any of a Group HA, IIIA, IVA, VA, VIA, VIIA, VIIIA, IB, IIB, IIIB, IVB, VB, and VIB metal; D is at least one of oxygen (O), nitrogen (N), carbon (C), or a halogen; 0.0001<a≦0.1 and x, y, z are >0. In compositions having an ordered olivine structure and of general formula Liₓ(M′_{1-a-y}M″ₐLi_{y})PO₄, M′, M″, x and a are selected such that there can be subvalent Li substituted onto an M2 site for M′ or M″ can act as an acceptor defect.

U.S. Pat. No. 6,962,666 to Ravet al. concerns alkali metal based oxides of formula AₐMₘZ_{z}OₒNₙF_{f} where A is an alkali metal Li, Na, or K; M is at least one transition metal, such as Fe, Mn, V, Ti, Mo, Nb, W or Zn and optionally at least one non-transition metal, such as Mg and Al; Z is at least one non-metal S, selenium (Se), P, As, Si, Ge or B; O is oxygen; N is nitrogen, F is fluorine and coefficients a, m, z, o, n, f≧0. Particles of the material further comprise a non powdery surface coating of an electrically conductive carbonaceous material and the coefficients a, m, z, o, n, f are selected to avoid oxidation of the carbonaceous material during deposition. U.S. Pat. Nos. 6,855,273 and 7,344,659, both to Ravet al., respectively concern a method of making such a material and an electrochemical cell having an electrode comprising such a material.

U.S. Pat. No. 7,087,348 to Holman et al. discloses coating lithium iron phosphate particles with electronically conductive and low refractive index materials.

### SUMMARY OF THE INVENTION

The present invention arose in an endeavor to provide an electrode material for an alkali metal electrochemical cell that at least in part has an improved performance over the known electrode materials. Electrode materials of the invention relate to metal phosphate materials having an olivine structure and a general composition M1M2PO₄ in which alkali metal cations, such as lithium (Li), occupy M1 octahedral sites and a metal having more than one oxidation state, such as iron (Fe), occupy M2 octahedral sites. Embodiments of the invention comprise such a material in which one or more trivalent and/or tetravalent transition or non transition metal cations are doped into an M2 site and in which additional alkali metal cations are doped into an M1 site to maintain charge balance.

According to the invention an electrode material for an electrochemical cell comprises: a metal phosphate of general composition M1M2PO₄ having an olivine structure in which alkali metal cations occupy M1 octahedral sites and transition metal cations occupy M2 octahedral sites wherein the transition metal can have both divalent and trivalent oxidation states, characterized by: trivalent and/or tetravalent metal cations doped into an M2 site and additional alkali metal cations doped into an M2 site, wherein when trivalent metal cations are doped into an M2 site the same number of alkali metal cations are doped into an M2 site to thereby attain an overall charge balance of the material and wherein when tetravalent metal cations are doped into an M2 site twice as many alkali metal cations are doped into M2 sites to thereby attain an overall charge balance of the material. The electrode material of the invention has an improved discharge capacity and capacity retention in comparison with an undoped host material M1M2PO₄.

To enable migration of the alkali metal ions during discharge and charge cycles the electrode material has an olivine structure. To maintain a stable olivine structure the trivalent and tetravalent metal cations have an ionic radius that is less than or equal to the ionic radius of the transition metal cation in its divalent oxidation state. Additionally the trivalent and tetravalent metal cations have an ionic radius that is no smaller than 10% of the ionic radius of the transition metal cation in a trivalent oxidation state.

For a Li-ion electrochemical cell the alkai metal cation can comprise lithium (Li⁺) though it is contemplated that it can comprise sodium (Na⁺), potassium (K⁺) or a mixture thereof.

The trivalent dopant metal cation is preferably selected from group 13 of the periodic table, such as aluminum (Al³⁺), gallium (Ga³⁺), indium (In³⁺), thallium (Tl³⁺); from group 3 of the periodic table, such as yttrium (Y³⁺), lanthanum (La³⁺) or from the first row of the transition metals, such as vanadium (V³⁺), chromium (Cr³⁺), manganese (Mn³⁺), iron (Fe³⁺), cobalt (Co³⁺) or a mixture thereof.

The tetravalent dopant metal cation can comprise titanium (Ti⁴⁺), zirconium (Zr⁴⁺), molybdenum (Mo⁴⁺), tungsten (W⁴⁺) or a mixture thereof.

The transition metal cation has more than one oxidation state such that it can be oxidized to a higher oxidation state during electrochemical reaction and can comprise iron (Fe²⁺), manganese (Mn²⁺), cobalt (Co²⁺) or a mixture thereof.

Additionally the electrode material can further comprise divalent metal ions doped into an M2 site. The divalent metal cations can comprise an alkali earth metal such as magnesium (Mg²⁺), calcium (Ca²⁺), strontium (Sr²⁺), barium (Ba²⁺) or a first row transition metal such as chromium (Cr²⁺), manganese (Mn²⁺), cobalt (Co²⁺), nickel (Ni²⁺), copper (Cu²⁺), zinc (Zn²⁺) or mixture thereof.

According to a further aspect of the invention an electrode material for an electrochemical cell comprises a material having an olivine structure and a general formula M^{I}(M^{I}_{x+2y}M^{III}ₓM^{IV}_{y}M^{II}_{z}M^{V}_{1-2x-3y-z})PO₄ in which M^{I} are monovalent alkali metal cations, M^{III} is one of a trivalent non transition and a transition metal cation, M^{IV} is a tetravalent transition metal cation, M^{II} is one of a divalent transition metal and non transition metal cation, M^{V} is a metal selected from the first row of transition metals and can have both divalent and trivalent oxidation states, wherein 0≦x, y, z≦0.500, x and y are not simultaneously equal to zero and wherein when x trivalent metal cations occupy a site of an M^{V} cation, x additional alkali metal cations are doped into a site of an M^{V} cation to balance the overall charge balance of the material and wherein when y tetravalent metal cations occupy a site of an M^{V} cation, 2y additional alkali metal cations are doped into an site of an M^{V} cation to balance the overall charge balance of the material. Throughout this patent specification parenthesis are used in the formulae for the electrode materials of the invention to indicate the metals that can occupy the same site, M2 site of the olivine structure. In the electrode material of the invention it is believed that the trivalent M^{III} and/or tetravalent M^{IV} cations dope into the site of the transition metal M^{V} whilst additional alkali metal ions occupy such a site to balance the overall charge balance of the material. In the generalized formula x trivalent M^{III}, y tetravalent M^{IV} and z divalent M^{II} metal cations dope into x+y+z transition metal M^{V} sites and x+2y additional alkali metal cations substitute a corresponding number of transition metal sites to balance the charge.

Preferably the divalent, trivalent and/or tetravalent metal cations are doped in the material such that 0≦x, y, z≦0.200.

For a Li-ion electrochemical cell the alkali metal cation can comprise lithium (Li⁺) though it is contemplated that it can comprise sodium (Na⁺), potassium (10 or a mixture thereof.

The trivalent metal cation M^{III} can comprise Al³⁺, Ga³⁺, In³⁺, Tl³⁺, Y³⁺, La³⁺, V³⁺, Cr³⁺, Mn³⁺, Fe³⁺, Co³⁺ or a combination thereof.

The tetravalent metal cation M^{IV} can comprise Ti⁴⁺, Zr⁴⁺, Mo⁴⁺, W⁴⁺ or combinations thereof.

The transition metal M^{V} can comprise Fe²⁺, Mn²⁺, Co²⁺ or a combination thereof.

The divalent metal cation M^{II} can comprise an alkali earth metal, a first row transition metal or a combinations thereof and is preferably Mg³⁺, Ca²⁺, Sr²⁺, Ba²⁺, Cr²⁺, Mn²⁺, Co²⁺, Ni²⁺, Cu²⁺ or Zn²⁺.

To increase the electrical conductivity of the electrode material, particles of the material are preferably coated with carbon.

In preferred compositions the trivalent and/or tetravalent metal cations have an ionic radius that is less than or equal to the ionic radius of the transition metal cation M^{V} in a divalent oxidation state. Additionally the trivalent and/or tetravalent metal cations have an ionic radius that is no smaller than 10%, preferably 5%, the ionic radius of the transition metal cation M^{V} in a trivalent oxidation state.

In one embodiment the electrode material is doped only with trivalent metal cations M^{III} (i.e. y=z=0) and the material has a formula M^{I}(M^{I}ₓM^{III}ₓM^{V}₁₋₂ₓ)PO₄. Examples of such materials include Li(LiₓCOₓFe₁₋₂ₓ)PO₄, Li(LiₓGaₓFe₁₋₂ₓ)PO₄ and Li(LiₓVₓFe₁₋₂ₓ)PO₄. In such an material the metal cations dope into a position (M2) of an M^{V} transition metal and additional M^{I} alkali metal cations substitute an M^{V} cation to balance the charge of the material. To maintain a stable structure the ionic radii of M^{I} and are approximately the same as the ionic radius of M^{V}. For example in the materials Li(LiₓCOₓFe₁₋₂ₓ)PO₄; Li(LiₓGaₓFe₁₋₂ₓ)P O₄ and Li(LiₓVₓFe₁₋₂ₓ)PO₄ the ionic radii are respectively Li⁺=68 pm, Co³⁺=63 pm, Ga³⁺=62 pm, V³⁺=74 pm, Fe³⁺=64 pm and Fe²⁺=74 pm. Such electrode materials can additionally be doped with divalent metal cations M^{II} and have a formula M^{I}(M^{I}ₓM^{III}ₓM^{II}_{z}M^{V}_{1-2x-z})PO₄. Examples of such materials include Li(LiₓCOₓNi_{z}Fe_{1-2x-z})PO₄; Li(LiₓCOₓMg_{z}Fe_{1-2x-z})PO₄; Li(LiₓCOₓZn_{z}Fe_{1-2x-z})PO₄; Li(LiₓCOₓCa_{z}Fe_{1-2x-z})PO₄ and Li(LiₓCOₓBa_{z}Fe_{1-2x-z})PO₄. In such a material trivalent and divalent metal cations dope into M^{V} transition metal sites (M2) and additional alkali metal cations M^{I} substitute a transition metal cation M^{V} to balance the charge of the material. To maintain a stable structure the ionic radii of the alkali and divalent metal cations are approximately the same as the ionic radius of the transition metal cation, For example in the material Li(Li_{0.03}CO_{0.03}Ni_{0.02}Fe_{0.92})PO₄ the ionic radii are respectively Li⁺=68 pm, Co³⁺=63 pm, Ni²⁺=69 pm, Fe³⁺=64 pm and Fe²⁺=74 pm. In other embodiments it is envisaged that comprise a mixture of two or more trivalent non transition or transition metal cations and can include for example Li(Li_{0.05}CO_{0.03}V_{0.02}Fe_{0.90})PO₄ and Li(Li_{0.05}CO_{0.03}Ga_{0.02}Fe_{0.90})PO₄.

In another embodiment the electrode material is doped only with tetravalent metal cations M^{IV} (x=z=0) and the electrode material is a formula M^{I}(M^{I}_{2y}M^{IV}_{y}M^{V}_{1-3y})PO₄. An example of such a material is Li(Li_{2y}W_{y}Fe_{1-3y})PO₄. In such an electrode material the tetravalent cation M^{IV} dopes into a position (M2) of the M^{V} cation and two additional alkali metal cations M^{I} ions substitute a transition metal cation M^{V} to balance the charge of the material. To maintain a stable structure the ionic radii of M^{I} and M^{IV} are substantially the same as the ionic radius of M^{v}. For example in the material Li(Li_{2y}W_{y}Fe_{1-3y})PO₄ the ionic radii are respectively Li⁺=68 pm, W⁴⁺=70 pm, Fe³⁺=64 pm and Fe²⁺=74 pm. Such an electrode material can be additionally doped with a divalent metal cations M^{II} and the electrode material is a formula M^{I}(M^{I}_{2y}M^{IV}_{y}M^{II}_{z}M^{V}_{1-3y-z})P_{O4}. An example of such a material is Li(Li_{2y}W_{y}Ni_{z}Fe_{1-3y-z})PO₄. In such an electrode material the tetravalent and divalent metal cations ions substitute transition metal cations M^{V} and additional alkali metal cations M^{I} ions substitute transition metal cations to balance the charge of the material. To maintain a stable structure the ionic radii of M^{I}, M^{IV} and M^{II} are approximately the same as the ionic radius of M^{V}.

In yet another embodiment the electrode material is doped with a mixture of trivalent metal cations M^{III} and tetravalent metal cations M^{IV} (z=0) and the electrode material is a formula M^{I}(M^{I}_{x+2y}M^{III}ₓM^{IV}_{y}M^{V}_{1-2x-3y})PO₄. An example of such a material is Li(Li_{x+2y}COₓW_{y}Fe_{1-2x-3y})PO₄. In such an electrode material the trivalent and tetravalent cations dope into a transition metal cation M^{V} position (M2 site) and an additional three alkali metal cations M^{I} substitute a transition metal cation M^{V} to balance the charge of the material. To maintain a stable structure each of the ionic radii of the alkali metal M^{I}, trivalent metal cation M^{III} and tetravalent metal cations M^{IV} are approximately the same as the ionic radius of the transition metal cation M^{V}. For example in the material Li(Li_{x+2y}COₓW_{y}Fe_{1-2x-3y})PO₄ the ionic radii are respectively Li⁺=68 pm, Co³⁺=63 pm, W⁴⁺=70 pm, Fe³⁺=64 pm and Fe²⁺=74 pm.

According to a further aspect of the invention a method of fabricating the electrode material of the invention comprises: a) mixing in stoichiometric proportions M^{I}, M^{II}, M^{III}, M^{IV}, M^{V} ion providing compounds and a phosphate providing compound; and b) calcining the reaction mixture. To carbon coat the particles of the electrode material the method can further comprise adding an organic polymer in step a). The mixing can comprise dry mixing or wet mixing.

### BRIEF DESCRIPTION OF THE DRAWINGS

In order that the present invention is better understood electrode material in accordance with the invention and their method of preparation will now be described, by way of example only, with reference to the accompanying drawings in which:

FIG. 1 is a representation of an electrode material M^{I}(M^{V}: M^{I}/M^{III}, M^{I}/M^{IV}, M^{II})PO₄ in accordance with the invention having an olivine structure;

FIG. 2 shows x-ray diffraction results for lithium/aluminum (Li/Al) and lithium/gallium (Li/Ga) doped LiFePO₄ electrode materials in accordance with the invention and triphylite LiFePO₄ for comparison;

FIG. 3 shows voltage/discharge capacity plots in a range 2.0 to 4.1 volts at room temperature (≈20° C.) with a charge rate of 0.2 C and a discharge rate of 0.5 C for a Li-ion electrochemical cell with a cathode containing undoped LiFePO₄; lithium/aluminum (Li/Al) and lithium/gallium (Li/Ga) doped LiFePO₄ electrode materials in accordance with the invention;

FIG. 4 shows voltage/discharge capacity plots in a range 2.0 to 4.1 volts at room temperature (≈20° C.) with a charge rate of 0.2 C and a discharge rate of 0.5 C for a Li-ion electrochemical cell with a cathode containing undoped LiFePO₄; Li_{1.03}FePO₄ and LiLi_{0.02}Fe_{0.99}PO₄ electrode materials;

FIG. 5 shows voltage/discharge capacity plots in a range 2.0 to 4.1 volts at room temperature (≈20° C.) with a charge rate of 0.2 C and a discharge rate of 0.5 C for a Li-ion electrochemical cell with a cathode containing undoped LiFePO₄ and lithium/iron (Li/Fe) doped LiFePO₄ electrode materials in accordance with the invention of a formula Li(LiₓFeₓFe₁₋₂ₓ)PO₄ for values of x=0.01, 0.02 and 0.03;

FIG. 6 shows x-ray diffraction results for triphylite LiFePO₄ and electrode materials Li(Li_{0.03}CO_{0.03}Fe_{0.90}PO₄ and Li(Li_{0.02}W_{0.01}Fe_{0.97})PO₄ in accordance with the invention;

FIG. 7 shows voltage/discharge capacity plots in a range 2.0 to 4.1 volts at room temperature (≈20° C.) with a charge rate of 0.2 C and a discharge rate of 0.5 C for a Li-ion electrochemical cell with a cathode containing undoped LiFePO₄ and a lithium/tungsten (Li/W) doped electrode material Li(Li_{0.02}W_{0.01}Fe_{0.97})PO₄ in accordance with the invention;

FIG. 8 shows charge and discharge curves in a range 2.0 to 4.1 volts at room temperature (≈20° C.) with a charge rate of 0.2 C and a discharge rate of 0.5 C for a Li-ion electrochemical cell with a cathode containing undoped LiFePO₄ and a lithium/cobalt (Li/Co) doped electrode material Li(Li_{0.03}CO_{0.03}Fe_{0.94})PO₄ in accordance with the invention; and

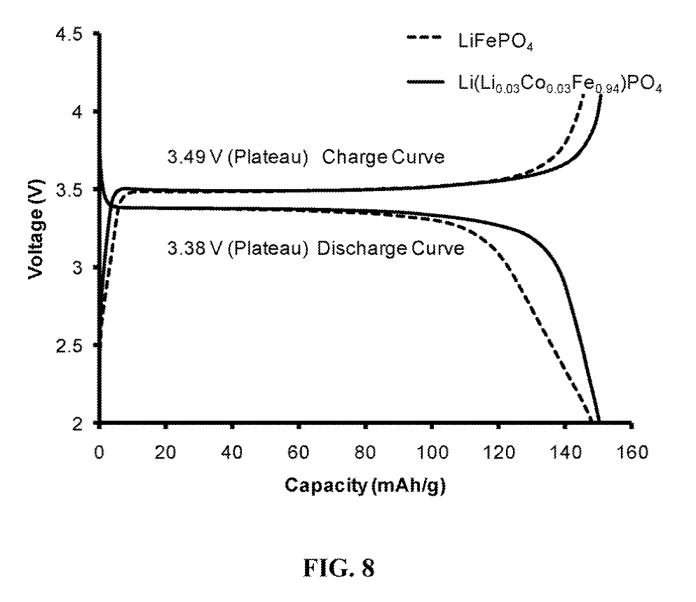

FIG. 9 shows voltage/discharge capacity plots in a range 2.0 to 4.1 volts at room temperature (≈20° C.) with a charge rate of 0.2 C and a discharge rate of 0.5 C for a Li-ion electrochemical cell with a cathode containing undoped LiFePO₄ and lithium/cobalt/nickel (Li/Co,Ni); lithium/cobalt/vanadium (Li/Co,Li/V) and lithium/cobalt/gallium (Li/Co,Li/Ga) doped electrode materials in accordance with the invention.

### DESCRIPTION OF THE INVENTION

The invention is illustrated by way of example and not by way of limitation in the figures of the accompanying drawings. It should be noted that references to ‘an’ or ‘one’ embodiment in this disclosure are not necessarily to the same embodiment, and such references mean at least one. In the following description, various aspects of the present invention will be described. However, it will be apparent to those skilled in the art that the present invention may be practiced with only some or all aspects of the present invention. For the purposes of explanation, specific numbers, materials, and configurations are set forth in order to provide a thorough understanding of the present invention. However, it will be apparent to one skilled in the art that the present invention may be practiced without the specific details. In other instances, well-known features are omitted or simplified in order not to obscure the present invention. Parts of the description will be presented in chemical synthesis terms, such as precursors, intermediates, product, and so forth, consistent with the manner commonly employed by those skilled in the art to convey the substance of their work to others skilled in the art. As well understood by those skilled in the art, these are labels, and may otherwise be manipulated through synthesis conditions. Various operations will be described as multiple discrete steps in turn, in a manner that is most helpful in understanding the present invention, however, the order of description should not be construed as to imply that these operations are necessarily order dependent. Various embodiments will be illustrated in terms of exemplary classes of precursors. It will be apparent to one skilled in the art that the present invention can be practiced using any number of different classes of precursors, not merely those included here for illustrative purposes. Furthermore, it will also be apparent that the present invention is not limited to any particular mixing paradigm.

### ABBREVIATIONS

The following abbreviations are used:

M=a metal;

M^{I}=a monovalent metal cation which has a +1 oxidation state;

M^{II}=a divalent metal cation which has a +2 oxidation state;

M^{III}=a trivalent metal cation which has a +3 oxidation state;

M^{IV}=a tetravalent metal cation which has a +4 oxidation state;

M^{V}=a multivalent metal cation which has more than one oxidation state, typically +2 and +3 oxidation states;

C=is a charge or discharge rate equal to the capacity of an electrochemical cell in one hour; and

pm=picometer.

### DEFINITIONS

“Secondary electrochemical cell (battery)” is a rechargeable electrochemical cell, also known as a storage battery, and comprises a group of two or more secondary cells.

“Olivine” structure is a group of materials of the general formula MZO₄. Olivines crystallize in the orthorhombic crystal system with isolated ZO₄ tetrahedrons bound to each other only by ionic bonds from interstitial M cations. The structure of olivine compounds can be viewed as a layered close-packed oxygen network, with Z ions occupying some of the tetrahedral voids and the M cations occupying some of the octahedral voids. One example, is LiFePO₄ in which the olivine structure consists of a mostly close-packed hexagonal array of oxygen anions, with a phosphate group (PO₄) occupying ⅛ of the tetrahedral sites, and the Li and Fe cations each occupying ½ of the octahedral sites. In LiFePO₄ there can be two distinct octahedral sites M1, M2 in which the M1 site is slightly more distorted than the M2 site. A crystal structure is ordered where the atoms of different elements seek preferred lattice positions.

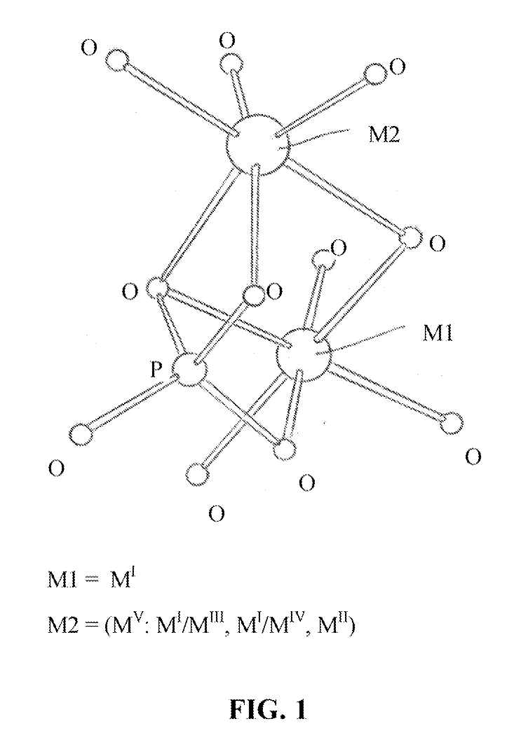

Electrode materials of the invention relate to metal phosphates having an olivine structure and general composition M1M2PO₄ where alkali metal cations M^{I} such as lithium (Li) occupy M1 octahedral sites and multivalent metal cations M^{V} having more than one oxidation state, such as iron (Fe), occupy the M2 octahedral sites (FIG. 1). Embodiments of the invention comprise such a material that is doped with one or more trivalent M^{III} and/or tetravalent M^{IV} transition or non transition metal cations that occupy an M2 site and in which additional alkali metal cations M^{I} substitute at least one multivalent cation M^{V} to attain charge balance of the material. Additionally divalent metal cations M^{II} can be doped into M2 sites of the material. In its general form electrode materials of the invention are of formula: M^{I}(M^{V}: M^{I}/M^{II}, M^{I}/M^{IV}, M^{II})PO₄. In this patent specification parenthesis in the material formulae indicate the metals cations that can occupy the same site and the metal cations appearing after the colon indicating those which substitute the multivalent metal cations M^{V}.

The electrode material is intended for use as an electrode, typically the cathode, in a rechargeable electrochemical cell.

More specifically electrode materials of the invention are of a formula: M^{I}(M^{I}_{x+2y}M^{III}ₓM^{IV}_{y}M^{II}_{z}M^{V}_{1-2x-3y-z})PO₄ where M^{I} is a +1 oxidation state alkali metal (e.g. Li⁺, Na⁺, K⁺), M^{III} is at least one +3 oxidation state non transition or transition metal (e.g. Al³⁺, Ga³⁺, In³⁺, Tl³⁺, Y³⁺, La³⁺, V³⁺, Cr³⁺, Mn³⁺, Fe³⁺, Co³⁺ or a mixture thereof), M^{IV} is at least one +4 oxidation state transition metal (e.g. Ti⁴⁺, Zr⁴⁺, Mo⁴⁺, W⁴⁺ or a mixture thereof), M^{II} is at least one +2 oxidation state transition metal or non transition metal (e.g. Mg²⁺, Ca²⁺, Sr²⁺, Ba²⁺, Cr²⁺, Mn²⁺, Co²⁺, Ni²⁺, Cu²⁺, Zn²⁺ or a mixture thereof), M^{V} is at least one metal selected from the first row of transition metals and can have more than one oxidation state (e.g. Fe²⁺, Mn²⁺, Co²⁺ or a mixture thereof) and 0≦x, y, z≦0.500 and x and y are not simultaneously equal to zero.

In the electrode material of the invention it is believed that the trivalent M^{III} and/or tetravalent M^{IV} metal cations substitute (dope into the site of) multivalent metal cations M^{V} and additional alkali metal cations M^{I} substitute (dope into the site of) at least one M^{V} metal cation to balance the charge of the material. The electrode material of the invention has an improved discharge capacity and capacity retention in comparison with an undoped host material M^{I}M^{V}P_{O4}.

In one series of electrode materials in accordance with the invention which are doped with trivalent metal cations M^{III}(i.e. y=z=0) the material can be represented by the formula M^{I}(M^{I}ₓM^{III}ₓM^{V}₁₋₂ₓ)PO₄. Examples of such materials include Li(LiₓGaₓFe₁₋₂ₓ) PO₄, Li(LiₓAlₓFe₁₋₂ₓ)PO₄, Li(LiₓVₓFe₁₋₂ₓ)PO₄ and Li(LiₓCOₓFe₁₋₂ₓ)PO₄. In such a material the trivalent metal cations M^{III} substitute (dope into the site of) multivalent metal cations M^{V} and a corresponding number of additional alkali metal cations M^{I} substitute (dope into the site of) multivalent metal cations M^{V} to balance the charge of the material. Such materials can additionally be doped with divalent metal cations M^{II} (i.e. y=0) and the material can then be represented by the formula M^{I}(M^{I}ₓM^{III}ₓM^{II}_{z}M^{V}_{1-2x-z})PO₄. An example of such a material is Li(LiₓCOₓNi_{z}Fe_{1-2x-z)PO}₄. In such a material the trivalent M^{III} and divalent M^{II} metal cations substitute (dope into the site of) multivalent metal cations M^{V} and additional alkali metal cations M^{I} corresponding to the number of trivalent metal cations M^{III} substitute (dope into the site of) multivalent metal cations M^{V} to balance the charge of the material.

In an another series of electrode materials in accordance with the invention which are doped with tetravalent metal cations (i.e. x=z=0) the material can be represented by the formula M^{I}(M^{I}_{2y}M^{IV}_{y}M^{V}_{1-3y})PO₄. An example of such a material is Li(Li₂W_{y}Fe_{1-3y})PO₄. In such a material the tetravalent metal cations M^{IV} substitute (dope into the site of) multivalent metal cations M^{V} and twice as many additional alkali metal cations M^{I} substitute (dope into the site of) multivalent metal cations M^{V} to balance the charge of the material. Such materials can additionally be doped with divalent metal cations M^{II} (i.e. x=0) and the material can then be represented by the formula M^{I}(M^{I}_{2y}M^{IV}_{y}M^{II}_{z}M^{V}_{1-3y-z})PO₄. An example of such a material is Li(Li_{2y}W_{y}Ni_{z}Fe_{1-3y-z})PO₄. In such a material the tetravalent M^{IV} and divalent M^{II} metal cations substitute (dope into the site of) multivalent metal cations M^{V} and additional alkali metal cations M^{I} corresponding to twice the number of tetravalent metal cations M^{IV} substitute (dope into the site of) multivalent metal cations M^{V} to balance the charge of the material.

In yet a further series of electrode materials in accordance with the invention which are doped with both trivalent M^{III} and tetravalent M^{IV} metal cations (i.e. z=0) the material can be represented by the formula M^{I}(M^{I}_{x+2y}M^{III}ₓM^{IV}_{y}M^{V}_{1-2x-3y})PO₄. An example of such a material is Li(Li_{x+2y}COₓW_{y}Fe_{1-2x-3y})PO₄. In such a material the trivalent M^{III} and tetravalent M^{IV} metal cations substitute (dope into the site of) multivalent metal cations M^{V} and additional alkali metal cations M^{I} corresponding to the sum of the number of trivalent metal cations M^{III} and twice number of tetravalent metal cations M^{IV} substitute (dope into the site of) multivalent metal cations M^{V} to balance the charge of the material. Such material can additionally be doped with divalent metal cations M^{II}.

Electrode Material Preparation

The performance of battery materials is highly dependent on the morphology, particle size, purity, and conductivity of the materials. For example, the crystal structure and space group for the superionic NASICON conductive material is rhombohedral/R-3C. In contrast, the crystal structure and space group for the LiFePO₄ is orthorhombic/Pnmb. Thus the arrangement of the tetrahedral and octahedral interstitial sites is different in the two structures, as evidenced by the various degrees and amounts of edge and corner sharing. This has significant consequences for lithium conductivity. Furthermore, different material synthesis processes can readily produce materials with different morphology, particle size, purity, or conductivity. As a result, the performance of the battery materials is highly dependent on the synthesis process.

A preferred method for preparing a lithium (Li) and other metal mixed phosphates of general formula Li(Li_{x+2y}M^{III}ₓM^{IV}_{y}M^{II}_{z}Fe_{1-2x-3y-z})PO₄ is now described. It will be appreciated that in such a composition M^{I}=Li and M^{v}=Fe. The electrode active material is prepared from an intimate mixture comprising in stoichiometric proportions: (i) a lithium (M^{I}) providing material, (ii) an iron (M^{V}) providing material, (iii) at least one doping metal (M^{III} and/or M^{IV} and optionally M^{II}) providing material(s) and (iv) a phosphate (PO₄³⁻) providing material.

The lithium providing material can comprise: lithium carbonate Li₂CO₃, lithium acetate LiCH₃COO, lithium oxalate Li₂C₂O₄, lithium nitrate LiNO₃, or lithium hydroxide LiOH. Lithium carbonate is preferred as it has a melting point that is higher than that at which the reaction takes place.

The iron provider can comprise iron oxalate FeC₂O₄, iron acetate Fe(CH₃COO)₂ or iron oxide Fe₂O₃ or Fe₃O₄.

The phosphate anion (PO₄³⁻) providing material may be ammonium dihydrogen phosphate NH₄H₂PO₄, ammonium hydrogen phosphate (NH₄)₂HPO₄, lithium phosphate Li₃PO₄ or lithium hydrogen phosphate LiH₂PO₄. Ammonium dihydrogen phosphate or ammonium hydrogen phosphate are preferred due to their relatively cheaper cost. In the case of the latter two these can also act as both a lithium and phosphate source.

The M^{III} doping metal providing material can comprise an M^{III} nitrate M^{III}(NO₃)₃ such as aluminum nitrate Al(NO₃)₃, gallium nitrate Ga(NO₃)₃ or lanthanum nitrate Lₐ(NO₃)₃; an M^{III} metal oxide such as manganese oxide (Mn₂O₃), cobalt oxide CO₃O₄, vanadium oxide V₂O₃ or chromium oxide Cr₂O₃; an M^{III} metal carbonate M^{III}₂(CO₃)₃ or an M^{III} metal acetate M^{III}(CH₃COO)₃.

The M^{IV} doping metal providing material can comprise an M^{IV} metal oxide M^{IV}O₂ such as tungsten oxide WO₂ or zirconium oxide ZrO₂; an M^{IV} metal nitrate M^{IV}(NO₃)₄ such as zirconium nitrate Zr(NO₃)₄ or zirconium oxynitrate ZrO(NO₃)₂; an M^{IV} metal carbonate such as zirconium carbonate or an M^{IV} metal acetate such as zirconium acetate Zr(CH₃CO₂)₄.

The M^{II} doping metal providing material can comprise an M^{II} nitrate M^{II}(NO₃)₂ such as nickel nitrate Nᵢ(NO₃)₂, zinc nitrate Zn(NO₃)₂, magnesium nitrate Mg(NO₃)₂ or calcium nitrate Ca(NO₃)₂; an M^{II} metal oxide such as manganese oxide NiO, zinc oxide ZnO, magnesium oxide MgO or calcium oxide CaO; an M^{II} metal carbonate M^{II}CO₃ such as nickel carbonate NiCO₃, zinc carbonate ZnCO₃, magnesium carbonate MgCO₃ or calcium carbonate CaCO₃ or an M^{II} metal acetate M^{II}(CH₃COO)₂ such as nickel acetate Ni(CH₃COO)₂, zinc acetate Zn(CH₃COO)₂, magnesium acetate Mg(CH₃COO)₂ or calcium acetate Ca(CH₃COO)₂.

The constituent precursor materials are added in stoichiometric proportions as stated in the formula. An organic polymer, such as glucose, sucrose, PEG (polyethylene glycol), PVA (polyvinyl alcohol), is added to the mixture and acts as a carbon source. Typically the organic polymer is 2 to 20% (wt.) of total raw material weight. It is believed that the carbon resulting from the decomposition of the organic polymer forms a homogeneous coating on particles of the final electrode material and that this can enhance conductivity of the electrode material.

The raw materials are thoroughly mixed by a dry or wet milling process, preferably wet milling with a volatile liquid such as acetone, for a few hours to several days. The resulting homogenous slurry is then dried by evaporating the liquid. After drying, the material mixture is ground to a powder which is then calcined at 500 to 800° C., preferably 600° C. to 700° C., for 1 to 12 hours under an inert or weak reducing atmosphere. When the furnace is cooled to ambient temperature, the samples are removed from the furnace. The heating and cooling ramp rate is typically in a range 2-5° C./min. The product after calcining, which is typically a black or grayish black powder, is then ground and sieved to obtain a fine powder with a particle size ranging from a few hundred nanometers to several micrometers.

Reference Material: LiFePO₄

LiFePO₄ was prepared as a comparison electrode material. The mixture of the following raw materials, Li₂CO₃ (6.553 g, 0.089 mol), FeC₂O₄ (31.279 g, 0.174 mol), NH₄H₂PO₄ (20.00 g, 0.174 mol) in a molar ratio of 0.51:1:1 with 5% (wt.) of sucrose (2.910 g) as a carbon source. The combined raw materials were well mixed in a wet ball mill with an acetone solution for 4, 7, 9 or 15 days. After removal of acetone the dried material was ground. The fine powder produced was calcined at 700° C. for 6 hours in a 5% H₂/N₂ atmosphere. The heating and cooling rates were 3° C./min. Finally the powder was ground and sieved.

An electrochemical cell with a LiFePO₄ cathode and a lithium anode was constructed with an electrolyte purchased from Ferro Corporation and the reversible capacity measured. Material milled for 4 days exhibited a reversible capacity of 120 mAh/g.

### Example 1

### Li(Li_{0.01}Ga_{0.01}Fe_{0.98})PO₄

In an embodiment of the invention an electrode material of formula Li(Li_{0.01}Ga_{0.01}Fe_{0.98})PO₄ was prepared from a mixture of Li₂CO₃ (6.617 g, 0.090 mol), FeC₂O₄ (30.653 g, 0.170 mol), NH₄H₂PO₄ (20.00 g, 0.174 mol) and Ga(NO₃)₃.xH₂O (x=7.7) (0.686 g, 1.74 mmol) in a molar ratio of 0.515:0.98:1:0.01 with a 5% (wt.) of sucrose (2.898 g) as a carbon source. The combined raw materials were well mixed by wet milling process in acetone for 4 days. After removal of the acetone the dried material was ground. The fine powder produced was then calcined at 700° C. for 6 hours in a 5% H₂/N₂ atmosphere. The heating and cooling rates were 3° C./min. Finally the powder was ground and sieved.

### Example 2

### Li(Li_{0.03}Ga_{0.03}Fe_{0.94})PO₄

An electrode material of formula Li(Li_{0.03}Ga_{0.03}Fe_{0.94})PO₄ was prepared from a mixture of Li₂CO₃ (6.746 g, 0.091 mol), FeC₂O₄ (29.402 g, 0.163 mol), NH₄H₂PO₄ (20.00 g, 0.174 mol) and Ga(NO₃)₃.xH₂O (x=7.7) (2.057 g, 5.2 mmol) in a molar ratio of 0.525:0.94:1:0.03 with 5% (wt.) of sucrose (2.910 g) as a carbon source. The method of preparation was the same as used in Example 1.

### Example 3

### Li(Li_{0.01}Al_{0.01}Fe_{0.98})PO₄

An electrode material of formula Li(Li_{0.01}Al_{0.01}Fe_{0.98})PO₄ was prepared from a mixture of Li₂CO₃ (6.617 g, 0.090 mol), FeC₂O₄ (30.653 g, 0.170 mol), NH₄H₂PO₄ (20.00 g, 0.174 mol) and Al(NO₃)₃.9H₂O (0.652 g, 1.74 mmol) in a molar ratio of 0.515:0.98:1:0.01 with 5% (wt.) of sucrose (2.896 g) as a carbon source. The method of preparation was the same as that used to prepare Example 1.

### Example 4

### Li(Li_{0.03}Al_{0.03}Fe_{0.94})PO₄

An electrode material of formula Li(Li_{0.03}Al_{0.03}Fe_{0.94})PO₄ was prepared from a mixture of Li₂CO₃ (6.746 g, 0.091 mol), FeC₂O₄ (29.402 g, 0.163 mol), NH₄H₂PO₄ (20.00 g, 0.174 mol) and Al(NO₃)₃.9H₂O (1.957 g, 5.21 mmol) in a molar ratio of 0.525:0.94:1:0.03 with 5% (wt.) of sucrose (2.905 g) as a carbon source. The method of preparation was the same as used in the preparation of Example 1.

### Example 5

### Li(Li_{0.01}La_{0.01}Fe_{0.98})PO₄

An electrode material of formula Li(Li_{0.01}La_{0.01}Fe_{0.98})PO₄ was prepared from a mixture of Li₂CO₃ (6.617 g, 0.090 mol), FeC₂O₄ (30.653 g, 0.170 mol), NH₄H₂PO₄ (20.00 g, 0.174 mol) and La(NO₃)₃.6H₂O (0.652 g, 1.74 mmol) in a molar ratio of 0.515:0.98:1:0.01 with 5% (wt.) of sucrose (2.901 g) as a carbon source. The method of preparation was the same as that used to prepare Example 1.

### Example 6

### Li(Li_{0.03}La_{0.03}Fe_{0.94})PO₄

An electrode material of formula Li(Li_{0.03}La_{0.03}Fe_{0.94})PO₄ was prepared from a mixture of Li₂CO₃ (6.746 g, 0.091 mol), FeC₂O₄ (29.402 g, 0.163 mol), NH₄H₂PO₄ (20.00 g, 0.174 mol) and La(NO₃)₃.6H₂O (2.259 g, 5.21 mmol) in a molar ratio of 0.525:0.94:1:0.03 with 5% (wt.) of sucrose (2.920 g) as a carbon source. The method of preparation was the same as that used to prepare Example 1.

### Example 7

### Li(Li_{0.02}Zr_{0.01}Fe_{0.97})PO₄

An electrode material of formula Li(Li_{0.02}Zr_{0.01}Fe_{0.97})PO₄ was prepared from a mixture of Li₂CO₃ (6.681 g, 0.090 mol), FeC₂O₄ (30.340 g, 0.169 mol), NH₄H₂PO₄ (20.00 g, 0.174 mol) and ZrO₂ (0.214 g, 1.74 mmol) in a molar ratio of 0.52:0.97:1:0.01 with 5% (wt.) of sucrose (2.862 g) as a carbon source. The method of preparation was the same as that used to prepare Example 1.

### Example 8

### Li(Li_{0.06}Zr_{0.03}Fe_{0.91})PO₄

An electrode material of formula Li(Li_{0.06}Zr_{0.03}Fe_{0.91})PO₄ was prepared from a mixture of Li₂CO₃ (6.938 g, 0.094 mol), FeC₂O₄ (28.464 g, 0.158 mol), NH₄H₂PO₄ (20.00 g, 0.174 mol) and ZrO₂ (0.642 g, 5.21 mmol) in a molar ratio of 0.54:0.91:1:0.03 with 5% (wt.) of sucrose (2.802 g) as a carbon source. The method of preparation was the same as that used to prepare Example 1.

### Example 9

### Li(Li_{0.02}W_{0.01}Fe_{0.97})PO₄

An electrode material of formula Li(Li_{0.02}W_{0.01}Fe_{0.97})PO₄ was prepared from a mixture of Li₂CO₃ (6.681 g, 0.090 mol), FeC₂O₄ (30.340 g, 0.169 mol), NH₄H₂PO₄ (20.00 g, 0.174 mol) and WO₂ (0.375 g, 1.74 mmol) in a molar ratio of 0.52:0.97:1:0.01 with 5% (wt.) of sucrose (2.870 g) as a carbon source. The method of preparation was the same as that used to prepare Example 1.

### Example 10

### Li(Li_{0.06}W_{0.03}Fe_{0.91})PO₄

An electrode material of formula Li(Li_{0.06}Zr_{0.03}Fe_{0.91})PO₄ was prepared from a mixture of Li₂CO₃ (6.938 g, 0.094 mol), FeC₂O₄ (28.464 g, 0.158 mol), NH₄H₂PO₄ (20.00 g, 0.174 mol) and WO₂ (1.126 g, 5.22 mmol) in a molar ratio of 0.54:0.91:1:0.03 with 5% (wt.) of sucrose (2.826 g) as a carbon source. The method of preparation was the same as that used to prepare Example 1.

### Example 11

### Li(Li_{0.01}CO_{0.01}Fe_{0.98})PO₄

An electrode material of formula Li(Li_{0.01}Co_{0.01}Fe_{0.98})PO₄ was prepared from a mixture of Li₂CO₃ (6.489 g, 0.088 mol), FeC₂O₄ (30.653 g, 0.171 mol), NH₄H₂PO₄ (20.00 g, 0.174 mol) and Co₃O₄ (0.140 g, 0.58 mmol) in a molar ratio of 0.505:0.98:1:0.003 with 5% (wt.) of sucrose (2.864 g) as a carbon source. The mixture was milled for 7 days. After removal of the acetone the dried material was ground to a fine powder and then calcined at 700° C. for 6 hours in a 5% H₂/N₂ atmosphere. The heating and cooling rates were 3° C./min. Finally the powder was ground and sieved.

### Example 12

### Li(Li_{0.03}CO_{0.03}Fe_{0.94})PO₄

An electrode material of formula Li(Li_{0.03}CO_{0.03}Fe_{0.94})PO₄ was prepared using a similar process to aluminum and gallium doped materials (Examples 1 to 6) from mixture of Li₂CO₃ (6.617 g, 0.090 mol), FeC₂O₄ (29.402 g, 0.163 mol), NH₄H₂PO₄ (20.00 g, 0.174 mol) and Co₃O₄ (0.419 g, 1.74 mmol) in a molar ratio of 0.515:0.94:1:0.01 with 5% (wt.) of sucrose (2.822 g) as a carbon source. The method of preparation was the same as that used to prepare Example 11.

### Example 13

### Li(Li_{0.01}V_{0.01}Fe_{0.98})PO₄

An electrode material of formula Li(Li_{0.01}V_{0.01}Fe_{0.98})PO₄ was prepared from a mixture of Li₂CO₃ (6.489 g, 0.088 mol), FeC₂O₄ (30.653 g, 0.171 mol), NH₄H₂PO₄ (20.00 g, 0.174 mol) and V₂O₃ (0.130 g, 0.87 mmol) in a molar ratio of 0.505:0.98:1:0.005 with 5% (wt.) of sucrose (2.864 g) as a carbon source. The method of preparation was the same as that used to prepare Example 11.

### Example 14

### Li(Li_{0.03}V_{0.03}Fe_{0.94})PO₄

An electrode material of formula Li(Li_{0.03}V_{0.03}Fe_{0.94})PO₄ was prepared from a mixture of Li₂CO₃ (6.617 g, 0.090 mol), FeC₂O₄ (29.402 g, 0.163 mol), NH₄H₂PO₄ (20.00 g, 0.174 mol) and V₂O₃ (0.391 g, 2.61 mmol) in a molar ratio of 0.515:0.94:1:0.015 with 5% (wt.) of sucrose (2.820 g) as a carbon source. The method of preparation was the same as that used to prepare Example 11.

### Example 15

### Li(Li_{0.02}W_{0.01}Fe_{0.97})PO₄

An electrode material of formula Li(Li_{0.02}W_{0.01}Fe_{0.97})PO₄ was prepared from a mixture of Li₂CO₃ (6.681 g, 0.090 mol), FeC₂O₄ (30.340 g, 0.169 mol), NH₄H₂PO₄ (20.00 g, 0.174 mol) and WO₂ (0.375 g, 1.74 mmol) in a molar ratio of 0.520:0.97:1:0.01 with 5% (wt.) of sucrose (2.870 g) as a carbon source. The method of preparation was the same as that used to prepare Example 11.

### Example 16

### Li(Li_{0.03}CO_{0.03}Ni_{0.02}Fe_{0.92})PO₄

An electrode material of formula Li(Li_{0.03}Co_{0.03}Ni_{0.02}Fe_{0.92})PO₄ was prepared from a mixture of Li₂CO₃ (13.234 g, 0.179 mol), FeC₂O₄ (57.552 g, 0.320 mol), NH₄H₂PO₄ (40.00 g, 0.348 mol), CO₃O₄ (0.838 g, 3.46 mmol) and NiCO₃ (0.824 g, 6.94 mmol) in a molar ratio of 0.515:0.92:1.00:0.01:0.02 with 5% (wt.) of sucrose (5.622 g) as a carbon source. The method of preparation was similar to that used to prepare Li(Li_{0.01}Co_{0.01}Fe_{0.98})PO₄ (Example 11). After milling for 9 days, the sample was dried and then calcined at 700° C. for 6 h under a 5% H₂/N₂ atmosphere.

### Example 17

### Li(Li_{0.05}CO_{0.03}V_{0.02}Fe_{0.90}PO₄

An electrode material of formula Li(Li_{0.05}Co_{0.03}V_{0.02}Fe_{0.90})PO₄ was prepared from a mixture of Li₂CO₃ (13.492 g, 0.183 mol), FeC₂O₄ (56.302 g, 0.313 mol), NH₄H₂PO₄ (40.00 g, 0.348 mol), CO₃O₄ (0.838 g, 3.46 mmol) and V₂O₃ (0.520 g, 3.47 mmol) in a molar ratio of 0.525:0.90:1.00:0.01:0.01 with 5% (wt.) of sucrose (5.558 g) as a carbon source. The method of preparation was the same as that used to prepare Li(Li_{0.03}Co_{0.03}Ni_{0.02}Fe_{0.92})PO₄ (Example 16).

### Example 18

### Li(Li_{0.05}CO_{0.03}Ga_{0.02}Fe_{0.90}PO₄

An electrode material of the formula Li(Li_{0.05}CO_{0.03}Ga_{0.02}Fe_{0.90})PO₄ was prepared from a mixture of Li₂CO₃ (13.492 g, 0.183 mol), FeC₂O₄ (56.302 g, 0.313 mol), NH₄H₂PO₄ (40.00 g, 0.348 mol), CO₃O₄ (0.838 g, 3.46 mmol) and Ga(NO₃)₃.xH₂O (x=7.7) (2.728 g, 6.92 mmol) in a molar ratio of 0.525:0.90:1.00:0.01:0.02 with 5% (wt.) of sucrose (5.668 g) as a carbon source. The method of preparation was the same as that used to prepare Li(Li_{0.03}Co_{0.03}Ni_{0.02}Fe_{0.92})PO₄ (Example 16).

### Example 19

### Li(Li_{0.07}CO_{0.03}W_{0.02}Fe_{0.88})PO₄

An electrode material of formula Li(Li_{0.07}Co_{0.03}W_{0.02}Fe_{0.88})PO₄ was prepared from a mixture of Li₂CO₃ (6.874 g, 0.093 mol), FeC₂O₄ (27.525 g, 0.153 mol), NH₄H₂PO₄ (20.00 g, 0.174 mol), CO₃O₄ (0.419 g, 1.74 mmol) and WO₂ (0.751 g, 3.48 mmol) in a molar ratio of 0.535:0.88:1.00:0.01:0.02 with 5% (wt.) of sucrose (2.778 g) as a carbon source. The method of preparation was similar to that used to prepare Li(Li_{0.03}Co_{0.03}Ni_{0.02}Fe_{0.92})PO₄ (Example 16).

Electrode Material Physical Structure

X-ray diffraction analysis shows that all of the electrode materials in accordance with embodiments of the invention (Examples 1 to 19) have an olivine type structure (FIG. 1), which is the same as triphylite LiFePO₄. As is known channels within the olivine structure enables migration of lithium metal ions during discharge and charge cycles the electrode material. Moreover, no additional peaks corresponding to the starting materials were observed in the x-ray diffraction pattern indicating that the reaction is complete.

Electrochemical Cell

A cathode for an electrochemical cell (e.g. a Li-ion cell) may be made with the following components in the proper weight proportions: 60-90% by weight of the electrode material of the invention, 3-20% by weight of carbon black (Super P conductive carbon), and 3-20% by weight of a polymer binder. It will be appreciated that the weight percentage range is not critical and other ranges will be apparent to those skilled in the art. The cathode electrode used in the measurements contains 90% by weight of the electrode material, 5% by weight of Super P conductive carbon, and 5% by weigh of polyvinylidene difluoride (PVDF). A conventional meter bar or doctor blade apparatus is used to make a film from a casting solution. The film is dried in a vacuum oven for 15-40 min. A punch cell is made from the dried film.

An electrochemical cell composed of a cathode containing the electrode material, a metallic lithium anode, electrode separator and electrolyte was constructed with current collectors connected to cathode and anode. A battery capacitor analyzer was used to measure the charge/discharge capacities in a voltage range 2.0 to 4.1 volts at room temperature (≈20° C.) with the charge rate of 0.2 C and the discharge rate of 0.5 C. The conductive solvents used in the electrolyte may be ethylene carbonate (EC), dimethyl carbonate (DMC), diethylcarbonate (DEC), dipropylcarbonate (DPC) and ethylmethylcarbonate (EMC) or their mixtures. An example of a commonly used electrolyte salt is 1M (mol/l) LiPF₆ (lithium hexafluorophosphate). The electrolyte used in the measurements was purchased from Ferro Corporation (Independence, Ohio). The electrode separator can comprise a polymeric membrane to allow free ion transport.

Electrochemical Performance

In an embodiment of the invention, the lithium stuffed and doped materials have improved properties due to one or more factors including the size of the ionic radii of the cationic dopant metals and more specifically whether the size allows the cation to fit into the olivine structure, the degree to which interstitial sites are distorted and the position of the redox couple below the Fermi level of Li. In various embodiments of the invention, these factors in combination with processing variables, particle size and carbon content are important for generating an improved electrode material.

The electrode materials of the invention comprise substituting (doping) multivalent metal cations M^{V} with trivalent M^{III} and/or tetravalent M^{IV} metal cations and further substituting M^{V} cations with monovalent alkali metal cations M^{I} to attain charge balance within the material. The electrode material can be represented by the general formula M^{I}(M^{V}: M^{I}/M^{II}, M^{I}/M^{IV})PO₄ in which the parenthesis indicate the metal cations that can occupy the same site (M2 octahedral site of the olivine structure—FIG. 1) and the metal cations listed after colon are those which substitute (dope into) an M^{V} metal cation. When one M^{III} metal cation substitutes an M^{V} metal cation, one additional alkali metal cation M^{I} substitutes another M^{V} cation to maintain the charge balance of the material. To sustain the stability of the structure, M^{II}, M^{IV}, M^{II} and M^{I} should have an ionic radius that is similar to M^{V}. Ideally the doping metals have more than one stable oxidation states which oxidizes when lithium is removed and reduces when lithium is inserted. Under such conditions, high capacities can be achieved.

Li(LiₓM^{III}ₓFe₁₋₂ₓ)PO₄ Electrode Materials (Examples 1 to 6)

Using lithium/trivalent metal cation (Li/M^{III}) doped LiFePO₄ electrode materials as an example; the electrochemical performance of the materials and a possible explanation of the results is now described. As shown in Table 1. Li(LiₓM^{III}ₓFe₁₋₂ₓ)PO₄ where M^{III}=Ga or Al and x=0.01, 0.03 exhibits a better discharge capacity than undoped LiFePO₄ prepared under the same conditions.

TABLE 1
Discharge capacity of the (Fe: Li/Ga), (Fe: Li/Al), (Fe: Li/La)
doped and undoped LiFePO₄

| | Discharge capacity |
|---|---|
| Composition | (mAh/g) |
| LiFePO₄ | 120 |
| Li(Li_{0.01}Ga_{0.01}Fe_{0.98})PO₄ | 125 |
| Li(Li_{0.03}Ga_{0.03}Fe_{0.94})PO₄ | 134 |
| Li(Li_{0.01}Al_{0.01}Fe_{0.98})PO₄ | 128 |
| Li(Li_{0.03}Al_{0.03}Fe_{0.94})PO₄ | 122 |
| Li(Li_{0.01}La_{0.01}Fe_{0.98})PO₄ | 105 |
| Li(Li_{0.03}La_{0.03}Fe_{0.94})PO₄ | 115 |

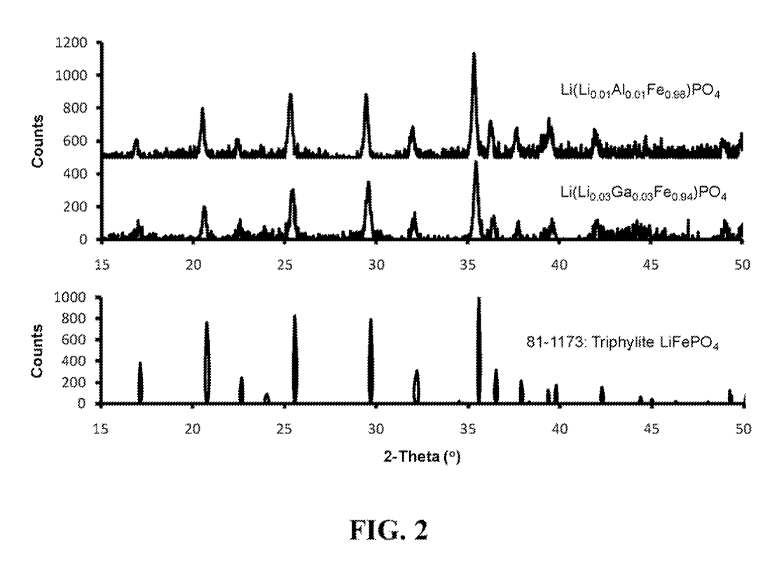

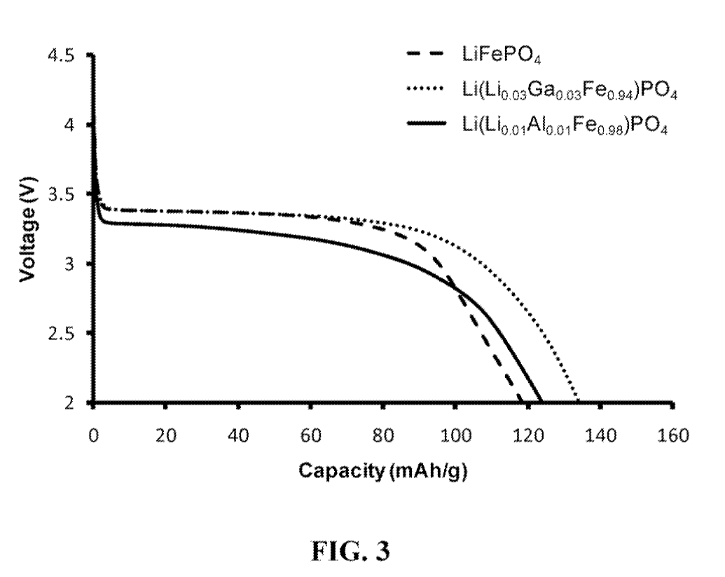

Lithium/aluminum (Li/Al) doped materials show a better discharge capacity at lower doping concentration (1%) and a decreased capacity at higher doping concentrations (3%). Lithium/Gallium (Li/Ga) doped materials exhibit improved capacity with increasing doping concentration (1%-3%). X-ray diffraction analysis of the (Li/Al) and (Li/Ga) doped materials are shown in FIG. 2 together with the X-ray pattern for triphylite LiFePO₄ for comparison. For ease of understanding the plots for the (Li/Al) and (Li/Ga) doped materials have been relatively displaced. As can be seen from FIG. 2 there are no peaks due to the presence of precursors indicating that the solid state reaction is essentially complete. It also demonstrates the formation of the olivine-type crystal structure, which is consistent with undoped LiFePO₄. The voltage vs. discharge capacity plot for (Li/Al) and (Li/Ga) doped materials are shown in FIG. 3, which show that the discharge capacity of Li(Li_{0.03}Ga_{0.03}Fe_{0.94})PO₄ is 134 mAh/g and that of Li(Li_{0.01}Al_{0.01}Fe_{0.98})PO₄ is 128 mAh/g. The undoped LiFePO₄ prepared under the same condition shows a discharge capacity of 120 mAh/g. Lithium, lanthanum (Li/La) doped materials, Li(Li_{0.03}La_{0.03}Fe_{0.94})PO₄ and Li(Li_{0.01}La_{0.01}Fe_{0.98})PO₄, have a lower discharge capacity (115 and 105 mAh/g) than undoped LiFePO₄ (Table 1). This might be explained by the difference in ionic sizes of the dopant and host cations (Table 2). The ionic radii of Ga³ and Li are similar to that of Fe²⁺ and Fe³⁺ whereas La³⁺ is relatively much larger. In the (Li/Ga) doped materials, the olivine structure is almost unchanged. Since Al³⁺ is relatively smaller than Fe²⁺ it may not attach at the host site (M2 octahedral site) and may cause structure distortion to destabilize it or may interfere with lithium transfer resulting in a reduced discharge capacity. It is unlikely that lanthanum could get into the FePO₄ framework since it would cause a big structure distortion in the framework.

TABLE 2
Ionic radii of various metal cations

| Metal cation | Ionic radius (pm) |
|---|---|
| Al³⁺ | 51 |
| Co²⁺ | 72 |
| Co³⁺ | 63 |
| Fe²⁺ | 74 |
| Fe³⁺ | 64 |
| Ga³⁺ | 62 |
| La³⁺ | 101.6 |
| Li⁺ | 68 |
| Ni²⁺ | 69 |
| V³⁺ | 74 |
| W⁴⁺ | 70 |
| W⁶⁺ | 62 |
| Zr⁴⁺ | 79 |

Li(Li_{2y}M^{IV}_{y}Fe_{1-3y})PO₄ Electrode Materials (Examples 7 to 10)

Examples of lithium/tetravalent metal cation (Li/M^{IV}) doped LiFePO₄ electrode materials; the electrochemical performance of the materials and a possible explanation of the results is now described. As shown in Table 3, Li(Li_{2y}W_{y}Fe_{1-3y})PO₄ where x=0.01, 0.03 exhibits a better discharge capacity than undoped LiFePO₄ prepared under the same conditions. While (Li/Zr) doped LiFePO₄, Li(Li_{2y}Zr_{y}Fe_{1-3y})PO₄ where x=0.01, 0.03, showed lower discharge capacity than undoped LiFePO₄ due to big ionic radius of zirconium (Zr⁴⁺=79 pm) compared to iron (Fe²⁺=74 pm). Tungsten has a ionic radius which is in between those of Fe²⁺ and Fe³⁺.

TABLE 3
Discharge capacity of the (Fe: Li/Zr), (Fe: Li/W) doped and
undoped LiFePO₄

| | Discharge capacity |
|---|---|
| Composition | (mAh/g) |
| LiFePO₄ | 120 |
| Li(Li_{0.02}Zr_{0.01}Fe_{0.97})PO₄ | 119 |
| Li(Li_{0.06}Zr_{0.03}Fe_{0.91})PO₄ | 117 |
| Li(Li_{0.02}W_{0.01}Fe_{0.97})PO₄ | 129 |
| Li(Li_{0.06}W_{0.03}Fe_{0.91})PO₄ | 127 |

Li(LiₓGaₓFe₁₋₂ₓ)PO₄ Electrode Materials

It is believed that lithium (M^{I}) cations substitute iron (M^{v}) to maintain charge balance when a gallium (M^{III}) metal cation dopes into the M^{V}PO₄ framework. Lithium/gallium (Li/Ga) doped materials show a discharge capacity of over 140 mAh/g. Assuming that lithium cannot substitute iron in the FePO₄ framework, the charge balance is maintained by the removal of outside lithium ions, which can be represented by the formula Li₁₋ₓGaₓFe₁₋ₓPO₄. Experimental results confirm this hypothesis. As can be seen in Table 4 electrode materials with of composition Li₁₋ₓGaₓFe₁₋ₓPO₄ exhibit much lower discharge capacities (<130 mAh/g) than those prepared under the same conditions and based on the formula: Li(LiₓGaₓFe₁₋₂ₓ)PO₄, whose discharge capacities are above 140 mAh/g.

TABLE 4
Discharge capacity of the lithium, gallium (Fe: Li/Ga) doped and
undoped LiFePO₄

| | Discharge capacity |
|---|---|
| Composition | (mAh/g) |
| LiFePO₄ | 148 |
| Li(Li_{0.02}Ga_{0.02}Fe_{0.96})PO₄ | 142 |
| Li(Li_{0.03}Ga_{0.03}Fe_{0.94})PO₄ | 140 |
| Li(Li_{0.04}Ga_{0.04}Fe_{0.92})PO₄ | 142 |
| Li(Li_{0.05}Ga_{0.05}Fe_{0.90}PO₄ | 141 |
| Li_{0.98}Ga_{0.02}Fe_{0.98}PO₄ | 126 |
| Li_{0.97}Ga_{0.03}Fe_{0.97}PO₄ | 115 |
| Li_{0.96}Ga_{0.04}Fe_{0.96}PO₄ | 114 |
| Li_{0.95}Ga_{0.05}Fe_{0.95}PO₄ | 90 |

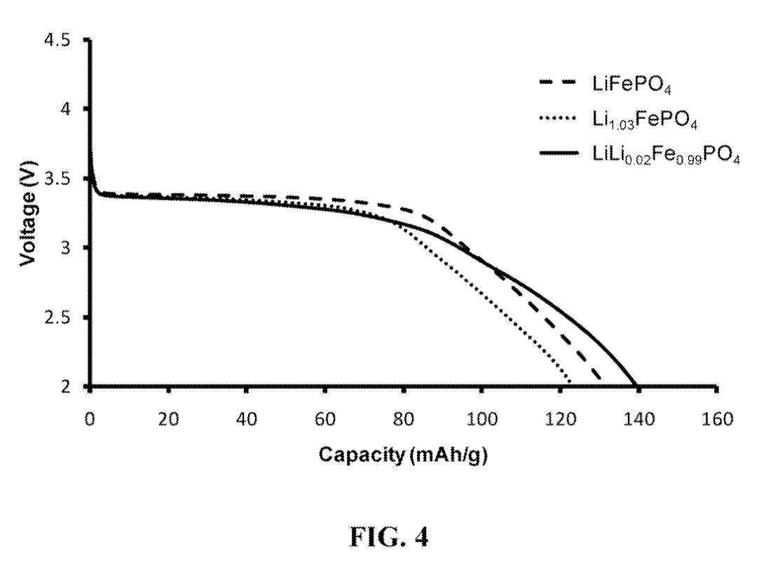

To confirm the hypothesis that lithium (M^{I}) cations substitute iron (M^{V}) to maintain charge balance when a trivalent metal cation (M^{III}) dopes into the M^{v}PO₄ framework, iron (M^{III}) doped LiFePO₄ electrode materials were prepared and tested. As can be seen from Table 5 increasing the quantity of lithium above its stoichiometric value decreases the discharge capacity (Li_{1.03}FePO₄ discharge capacity=123 mAh/g compared with LiFePO₄=130 mAh/g). The discharge capacity curves for Li_{1.03}FePO₄ and LiLi_{0.02}Fe_{0.99}PO₄ electrode materials are shown in FIG. 4. In contrast to materials with an excess amount of lithium it is found that materials in which the quantity of lithium is below its stoichiometric value have an increased discharge capacity. As can be seen from Table 5 for materials in which 1% and 3% of iron is removed and 2% and 6% of lithium is respectively added each show an increased discharge capacity of 138 mAh/g. Moreover it is found that if too much iron is removed (greater than about 5%) this can substantially decrease the discharge capacity. It is believed the decrease in discharge capacity results from there being less iron available to participate in the oxidation/reduction reaction.

TABLE 5
Discharge capacity of the lithium and iron doped LiFePO₄ and
undoped LiFePO₄

| | Discharge capacity |
|---|---|
| Composition | (mAh/g) |
| LiFePO₄ | 130 |
| Li_{1.03}FePO₄ | 123 |
| LiLi_{0.02}Fe_{0.99}PO₄ | 138 |
| LiLi_{0.06}Fe_{0.97}PO₄ | 138 |
| LiLi_{0.10}Fe_{0.95}PO₄ | 118 |

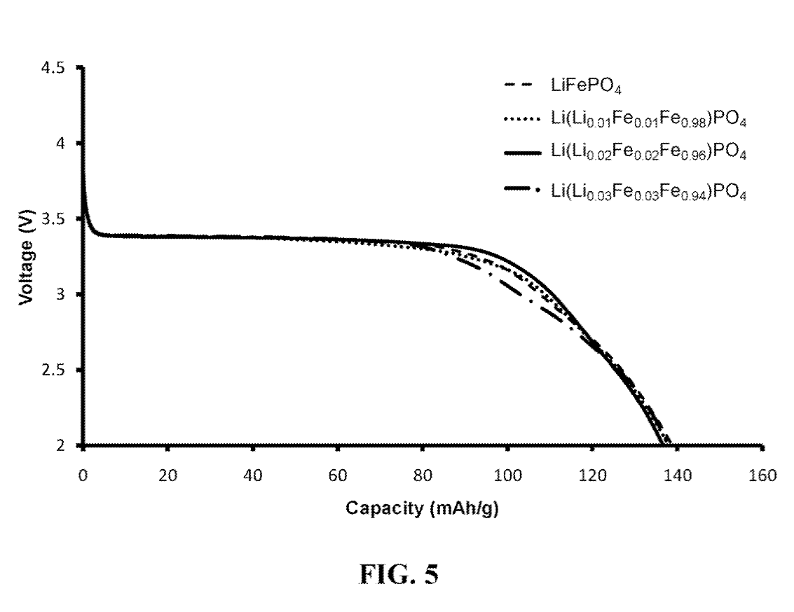

If it is correct that lithium (M^{I}) cations substitute iron (M^{V}) to maintain charge balance when a trivalent metal cation (M^{III}) dopes into the M^{V}PO₄ framework then such a material doped with M^{III}=Fe³⁺ should have a discharge capacity that is close to that of undoped LiM^{V}PO₄. Materials based on the formula Li(LiₓFe³⁺ₓFe²⁺₁₋₂ₓ)PO₄ for x=1%, 2%, 3% show close discharge capacities to the undoped material as shown by their discharge capacity curves (FIG. 5 and Table 6).

TABLE 6
Discharge capacity of the lithium, iron (Fe: Li/Fe) doped LiFePO₄
and undoped LiFePO₄

| | Discharge capacity |
|---|---|
| Composition | (mAh/g) |
| LiFePO₄ | 139 |
| Li(Li_{0.01}Fe³⁺_{0.01}Fe²⁺_{0.98})PO₄ | 137 |
| Li(Li_{0.02}Fe³⁺_{0.02}Fe²⁺_{0.96})PO₄ | 135 |
| Li(Li_{0.03}Fe³⁺_{0.03}Fe²⁺_{0.94})PO₄ | 136 |

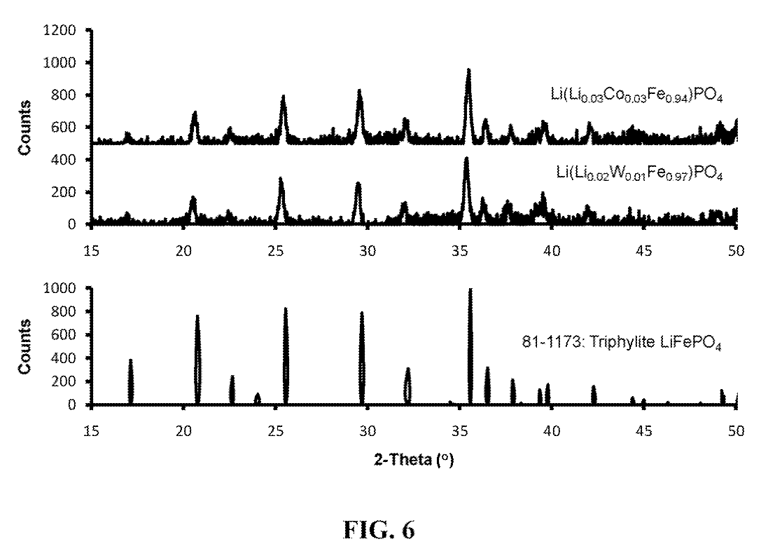

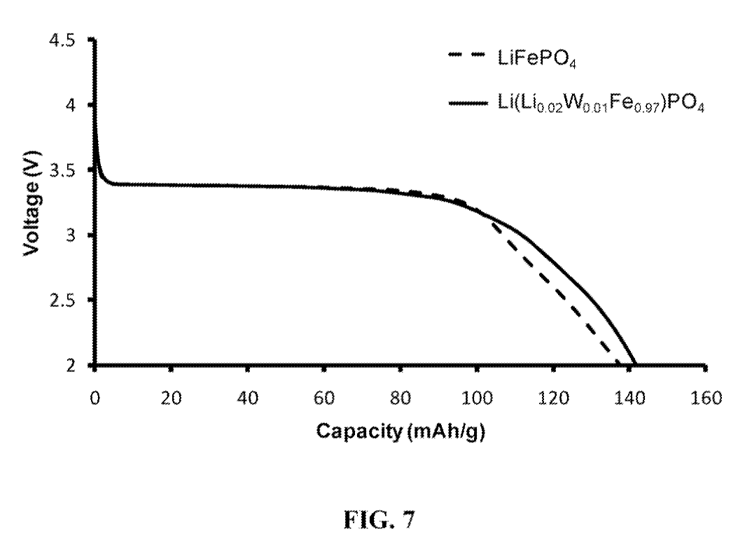

Since the ionic radii of cobalt, vanadium and tungsten are similar to that of iron (Co²⁺=72 pm; Co³⁺=63 pm; V³⁺=74 pm, V⁵⁺=59 pm, W⁴⁺=70 pm, Fe²⁺=74 pm and Fe³⁺=64 pm) it is believed that they can substitute iron (M^{V}) in the LiFePO₄ olivine structure. X-ray diffraction analysis of lithium/cobalt (Li/Co) and lithium/tungsten (Li/W) doped materials are shown in FIG. 6 together with the X-ray pattern for triphylite LiFePO₄ for comparison. For ease of understanding the plots for the (Li/Co) and (Li/W) doped materials have been relatively displaced. Measured discharge capacity values are tabulated in Table 7. The results show that the (Li/W) doped material Li(Li_{0.02}W_{0.01}Fe_{0.97})PO₄ prepared using similar procedure to prepare the (Li/Ga) doped material has a discharge capacity of 142 mAh/g (FIG. 7). Lithium, vanadium (Li/V) doped materials, Li(Li_{0.01}V_{0.01}Fe_{0.98})PO₄ and Li(Li_{0.03}V_{0.03}Fe_{0.94})PO₄, have discharge capacity of 143 and 142 mAh/g, respectively. Lithium, cobalt (Li/Co) doped materials have very high discharge capacities (148-150 mAh/g).

TABLE 7
Discharge capacity of the lithium, vanadium (Fe: Li/V); lithium,
cobalt (Fe: Li/Co) and lithium, tungsten (Fe: Li/W) doped LiFePO₄
and undoped LiFePO₄

| | Discharge capacity |
|---|---|
| Composition | (mAh/g) |
| LiFePO₄ | 139 |
| Li(Li_{0.01}Co_{0.01}Fe_{0.98})PO₄ | 148 |
| Li(Li_{0.03}Co_{0.03}Fe_{0.94})PO₄ | 150 |
| Li(Li_{0.01}V_{0.01}Fe_{0.98})PO₄ | 143 |
| Li(Li_{0.03}V_{0.03}Fe_{0.94})PO₄ | 142 |
| Li(Li_{0.02}W_{0.01}Fe_{0.97})PO₄ | 142 |

The material, Li(Li_{0.03}Co_{0.03}Fe_{0.94})PO₄, showed an increase in discharge capacity with the number of charge/discharge cycles. Initially it has a starting capacity of about 140 mAh/g and increases with each charge/discharge cycle. The discharge capacity relatively stabilizes after 53 cycles at which it shows a discharge capacity of about 150 mAh/g. The voltage vs. discharge capacity curve for the 59^{th} cycle is shown in FIG. 7. It is believed that the high discharge capacity shown in this material may be explained as follows. Both cobalt and iron have two stable oxidation states (+2 and +3) and consequently both of them can participate in the oxidation reduction process in the phosphate compound as lithium is removed and inserted during the electrochemical process. When such a material is used as a cathode within a Li-ion electrochemical cell and combined with suitable anode (typically metallic lithium), lithium ions are extracted from the cathode material during the first cycle and iron is oxidized Fe²⁺→Fe³⁺. When lithium ion is inserted into the phosphate, both Co³⁺ and Fe³⁺ can be reduced to a lower oxidation state. On the next cycle, both Co²⁺ and Fe²⁺ are oxidizable as lithium is removed resulting in a higher charge/discharge capacity.

Mixed Metal Doped Li(Li_{x+2y}M^{III}ₓM^{IV}_{y}M^{II}_{z}Fe_{1-2x-3y-z})PO₄ Electrode Materials

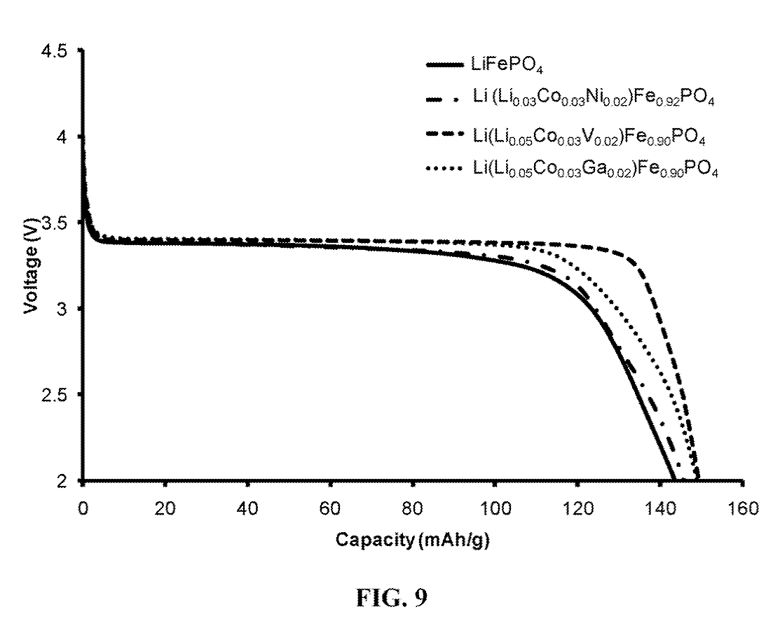

The inventors have also discovered that LiFePO₄ based electrode materials doped with lithium and two further metal dopants (trivalent metal cations M^{III}, tetravalent metal cations M^{IV}, divalent metal cations M^{II}) show an increased discharge capacity compared with undoped LiFePO₄. For example, discharge capacity and charge-discharge efficiency values are tabulated in Table 8 for lithium/cobalt/nickel (Li/Co, Ni), lithium/cobalt/vanadium (Li/Co, Li/V) and lithium/cobalt/gallium (Li/Co, Li/Ga) doped LiFePO₄. As can be seen from Table 8 and FIG. 9 such materials respectively have discharge capacity of 145 mAh/g, 148 mAh/g and 148 mAh/g.

TABLE 8
Discharge capacity and charge-discharge efficiency for lithium,
cobalt, nickel (Fe: Li/Co, Ni); lithium, cobalt, vanadium
(Fe: Li/Co, Li/V); lithium, cobalt, gallium (Fe: Li/Co, Li/Ga)
doped LiFePO₄ and undoped LiFePO₄

| | Discharge capacity | Charge-discharge |
|---|---|---|
| Composition | (mAh/g) | efficiency (%) |
| LiFePO₄ | 143 | 102 |
| Li (Li_{0.03}Co_{0.03}Ni_{0.02}Fe_{0.92})PO₄ | 145 | 97.7 |
| Li(Li_{0.05}Co_{0.03}V_{0.02}Fe_{0.90})PO₄ | 148 | 97.3 |
| Li(Li_{0.05}Co_{0.03}Ga_{0.02}Fe_{0.90})PO₄ | 148 | 92.8 |

It will be appreciated that the electrode material of the invention is not restricted to the specific embodiments described and variations can be made that are within the scope of the invention. For example it is contemplated that future electrochemical cell may be based on other alkali metal ions such as sodium (Na) or potassium (K) or a combination thereof. In such a cell the cathode material could contain an electrode material in accordance with the invention that is of general formula M^{I}(M^{V}: M^{I}/M^{III}, M^{I}/M^{IV}, M^{II})PO₄ where M^{I} is an alkali metal (Li, Na, K or a mixture thereof), M^{V} is a multivalent metal cation, M^{III} a trivalent metal cation dopant, M^{IV} is a tetravalent metal cation dopant and M^{II} is an optional divalent metal cation dopant. As represented in the formula the trivalent and tetravalent metal cations substitute (dopes into an M2 site) an M^{V} and as indicated by the slash character additional alkali metal cations substitute (dopes into an M2 site) M^{V} metal cations to attain charge balance of the material.

What is claimed is:

1. An electrode material for an electrochemical cell comprising:
a metal phosphate having an olivine structure and general composition M1M2PO₄ in which alkali metal cations occupy M1 octahedral sites and transition metal cations occupy M2 octahedral sites wherein the transition metal can have both divalent and trivalent oxidation states, characterized by:
trivalent and/or tetravalent metal cations doped into an M2 site and
an additional alkali metal cations doped into an M2 site,
wherein when trivalent metal cations are doped into an M2 site the same number of alkali metal cations are doped into an M2 site to thereby attain an overall charge balance of the material and wherein when tetravalent metal cations are doped into an M2 site twice as many alkali metal cations are doped into M2 sites to thereby attain an overall charge balance of the material.

2. The electrode material of claim 1, wherein the trivalent and tetravalent metal cations have an ionic radius that is less than or equal to the ionic radius of the transition metal cation in a divalent oxidation state.

3. The electrode material of claim 2, wherein the trivalent and tetravalent metal cations have an ionic radius that is no smaller than 10% of the ionic radius of the transition metal cation in a trivalent oxidation state.

4. The electrode material of claim 1, wherein the alkali metal is selected from the group consisting of: Li⁺, Na⁺, K⁺, and a combination thereof.

5. The electrode material of claim 1, wherein the trivalent cation is elected from the group consisting of: Al³⁺, Ga³⁺, In³⁺, Tl³⁺, Y³⁺, La³⁺, V³⁺, Cr³⁺, Mn³⁺, Fe³⁺, Co³⁺ and a combination thereof.

6. The electrode material of claim 1, wherein tetravalent metal cation is selected from group consisting of Ti⁴⁺, Zr⁴⁺, Mo⁴⁺, W⁴⁺ and combinations thereof.

7. The electrode material of claim 1, wherein the transition metal cation is selected from the
group consisting of: Fe²⁺, Mn²⁺, Co²⁺ and a combination thereof.

8. The electrode material of claim 1, and further comprising divalent cations doped into an M2 site wherein the divalent cations are selected from the group consisting of: Mg²⁺, Ca²⁺, Sr²⁺, Ba²⁺, Cr²⁺, Mn²⁺, Co²⁺, Ni²⁺, Cu²⁺, Zn²⁺ and a combination thereof.

9. An electrode material for an electrochemical cell having an olivine structure and a general formula: M^{I}(M^{I}_{x+2y}M^{III}ₓM^{IV}_{y}M^{II}_{z}M^{V}_{1-2x-3y-z})PO₄ in which M^{I} are monovalent alkali metal cations, is one of a trivalent non transition and a transition metal cation, M^{IV} is a tetravalent transition metal cation, M^{II} is one of a divalent transition metal and non transition metal cation, M^{V} is a metal selected from the first row of transition metals and can have both divalent and trivalent oxidation states, wherein 0≦x, y, z≦0.500, x and y are not simultaneously equal to zero and wherein when x trivalent metal cations occupy a site of an M^{V} cation, x additional alkali metal cations are doped into a site of an M^{V} cation to balance the overall charge of the material and wherein when y tetravalent metal cations occupy a site of an M^{V} cation, 2y additional alkali metal cations are doped into an site of an M^{V} cation to balance the overall charge of the material.

10. The electrode material of claim 9, wherein 0≦x, y, z≦0.200.

11. The electrode material of claim 9, wherein M^{I} is selected from the group consisting of: Li⁺, Na⁺, K⁺, and a combination thereof.

12. The electrode material of claim 9, wherein M^{III} is selected from the group consisting of: Al³⁺, Ga³⁺, In³⁺, Tl³⁺, Y³⁺, La³⁺, V³⁺, Cr³⁺, Mn³⁺, Fe³⁺, Co³⁺ and a combination thereof.

13. The electrode material of claim 9, wherein M^{IV} is selected from group consisting of Ti⁴⁺, Zr⁴⁺, Mo⁴⁺, W⁴⁺ and combinations thereof.

14. The electrode material of claim 9, wherein M^{V} is selected from the group consisting of Fe²⁺, Mn²⁺, Co²⁺ and a combination thereof.

15. The electrode material of claim 9, wherein M^{II} is selected from group consisting of: Mg²⁺, Ca²⁺, Sr²⁺, Ba²⁺, Cr²⁺, Mn²⁺, Co²⁺, Ni²⁺, Cu²⁺ or Zn²⁺ and a combination thereof.

16. The electrode material of claim 9, wherein the electrode materials comprise particles and further comprising a coating of carbon on said particles.

17. The electrode material of claim 9, wherein the trivalent and tetravalent metal cations have an ionic radius that is less than or equal to the ionic radius of M^{V} in a divalent oxidation state.

18. The electrode material of claim 17, wherein the trivalent and tetravalent metal cations have an ionic radius that is no less than 10% smaller than the ionic radius of M^{V} in a trivalent oxidation state.

19. A method of fabricating the electrode material of claim 9 comprising:
a) mixing in stoichiometric proportions M^{I}, M^{II}, M^{III}, M^{IV}, M^{V} ion providing compounds and a phosphate providing compound; and
b) calcining the reaction mixture.

20. The method of claim 19, and comprising adding an organic polymer in step a) and drying and grinding the reaction mixture before calcining it.
